(19) United States
(12) Patent Application Publication
(10) Pub. No.: US 2017/0373859 A1
(43) Pub. Date: Dec. 28, 2017

(54) Cryptographic Signature System and Related Systems and Methods

(71) Applicant: Praxik, LLC, Clive, IA (US)

(72) Inventors: Luke Shors, Minneapolis, MN (US); Aaron Bryden, Minneapolis, MN (US)

(21) Appl. No.: 15/631,928

(22) Filed: Jun. 23, 2017

Related U.S. Application Data
(60) Provisional application No. 62/353,879, filed on Jun. 23, 2016.

(51) Int. Cl. H04L 9/32

(52) U.S. Cl. CPC H04L 9/3247; H04L 9/3236; H04L 9/32

(57) ABSTRACT

The disclosed devices, systems, and methods relate to a validation system which can be used to authenticate photos and videos. The system can have various steps including; a user taking a photo or video, sensor data being collected by a processing system, the sensor data being hashed to create a cryptographic signature, and the cryptographic signature being stored. The cryptographic signature can be later compared with the correspond photo or video for purposes of authentication.

### CROSS-REFERENCE TO RELATED APPLICATION(S)

This application claims priority to U.S. Provisional Application No. 62/353,879 filed Jun. 23, 2016 and entitled “Cryptographic Signature System and Related Systems and Methods,” which is hereby incorporated by reference in its entirety under 35 U.S.C. §119(e).

### TECHNICAL FIELD

The disclosure relates to devices, systems, and methods for creating a timestamp and cryptographic signature used to enhance the security of photos and videos, accordingly decreasing the possibility and increasing traceability of any manipulation of photos or videos, particularly when those photos or videos are used as evidence.

### BACKGROUND

This disclosure relates to devices, systems, and methods for improving security of photos and videos, specifically by creating a timestamp and cryptographic signature that will allow for comparison in order to detect if any tampering has occurred. It is understood that tampering detection is particularly useful in many applications, such as when photos and videos are used as evidence and authenticity is critical.

Photos and videos are routinely collected and presented as evidence to establish the state of a physical space at a given time or an event that occurred at a particular place and time. For example, photo and video evidence can be used to document damage, or lack thereof, to a physical structure as part of claims, audits, or other inspections, or in documenting crime scenes. Currently, many issues with fraud exist as photos and videos are altered using editing software, changing the time or GPS stamp, or physically staging the environment for the purpose of creating an altered image. The current state of the art makes it difficult to distinguish forgeries from authentic content. This in turn can create doubt as to the authenticity of photos and videos when they are used in evidentiary contexts. Therefore, there is a need in the art for the technology and design principles allowing for tracking and authenticating data on photos and videos in order to make the photos and videos resistant to alteration.

### BRIEF SUMMARY

Discussed herein are various embodiments relating to a validation system used to create tamper-evident photo and video evidence for evidentiary proceedings. The various implementations of the disclosed validation system improve upon the prior art by pulling many different types of sensor data together to increase redundancy and generate unique cryptographic signatures based on the content of the data to enhance protection of photos and videos. Additionally, in alternate embodiments, the validation system may include an internal block chain, further improving upon the art.

Described herein are various embodiments relating to systems and methods for improving the reliability of photo and video data. Although multiple embodiments, including various devices, systems, and methods of improving the reliability of photos and videos are described herein as a “validation system,” this is in no way intended to be restrictive.

It is understood that at the time a user takes a photo or video, the validation system disclosed herein uses a processing system to collect data, hashes the data to create a cryptographic signature, and then stores the cryptographic signature. The type and amount of data collected and stored can vary among various embodiments. In alternate embodiments the data can be stored locally, on a database, or other system for storage as recognized by the art. After storage, the cryptographic signature can be compared to the data in the photo or video to authenticate that the photo or video has not been altered since the user took the photo or video. In alternate embodiments a public block chain can be utilized for an additional layer of security.

One non-limiting example could be that an insurance company could offer reduced premiums as an incentive to property policyholders in exchange for periodically documenting the safety of a property. The insurance company might wish to reduce the risk of a claim, as well as the inspection costs of sending an agent to the property, yet still want to ensure the authenticity of the collected information. The policyholder could use the insurance company's application containing the validation system herein disclosed for this purpose. The policyholder would be prompted by the application to periodically take select pictures of the property, for example of water heaters or other fire risks. The policyholder would then take the photos, which could then be established as authentic documentation of the state of the property using the cryptographic signature generated by the validation system herein disclosed.

In another example, a journalist might be investigating a contentious claim in a country that suppresses information. The journalist would use an application containing the validation system herein disclosed and take pictures or videos. The validation system disclosed herein would allow the journalist to attest to the authenticity of the photos and videos, including when and where they were taken. Additionally, the validation system would allow for a third party to look at the cryptographic signatures to ensure authenticity of the photos or videos, allowing for independent verification.

In a further example, a police officer may wish to document a crime scene. The officer uses the validation system disclosed herein while taking photos and videos of the scene. An expert witness in cryptography could later be called on to testify to a jury about the authenticity of the photo and video evidence. The validation system allows for further assurances that the photo or video documentation is authentic.

In yet an additional example, someone, perhaps an investigative journalist, who is very far from cellular range and using an inexpensive SPOT Satellite could use the validation system herein described. The individual could integrate their device with the validation system to transmit the cryptographic signatures of photos or videos at a low cost to the satellite. When the individual is in cellular or Wi-Fi range, the sensor data from the photos or videos could be uploaded to a server. This would allow the individual, or a third party, to authenticate each image or even preserve the sensor data although he or she might be out of cellular or Wi-Fi range. The validation system would allow for proving that the individual did not alter the image in the extensive period of time between taking the image and uploading it.

In another example, an attorney might need a client to review and sign a will that has been prepared. The attorney may wish to document that the client is signing the will as well as the mental competency of the client at the time the will is signed. The attorney could explain and flip through the document, taking video of the process, in the presence of the client. The client would then sign the document while being recorded on video. The validation system would create a cryptographic signature of the video that would be stored. This allows the attorney to document the entire process, including the mental status of the individual, in addition to the verifying who signed the will. In the event the will is contested the cryptographic signature can be used to verify that the video is authentic.

In various other examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Additional embodiments of the validation system could include, a database wherein the database is configured to store sensor data, and a processing system in communication with the database, where the processing system collects sensor data from a cellular device. Alternate embodiments may also include corresponding computer systems, apparatus, and/or programs recorded on one or more storage devices, each configured to perform actions of the system.

Implementations may include one or more of the following features. The validation system where the processing system stores sensor data locally in sensor data packets. The validation system where the processing system creates a local storage file—such as a zip or other compressed file—from the sensor data packets. The validation system where the processing system creates a cryptographic signature from the contents of the zip file. The validation system where: a) the processing system uploads the cryptographic signature to the database, and b) the upload occurs by way of a transmission on a network such as a cellular network or a Wi-Fi network. The validation system where the processing system is configured to measure and record a time lapse between storage of the sensor data and upload of the cryptographic signature. The validation system where the processing system uses the cryptographic signature to establish an internal ledger signature. The validation system where the internal ledger signature uploads periodically to the database. Various implementations may be put into effect in a variety of ways appreciated by those skilled in the art and may include hardware, a method or process, or computer software on a computer-accessible medium.

In additional examples, the validation system wherein the processing system is configured to validate the cryptographic signature and detect alterations. Other embodiments of this aspect include corresponding computer systems, apparatus, and computer programs recorded on one or more computer storage devices, each configured to perform the steps described. In another example, the validation system wherein the processing system is configured to validate the cryptographic signature against an internal ledger signature and detect alterations. Other embodiments of this aspect include corresponding computer systems, apparatus, and computer programs recorded on one or more computer storage devices, each configured to perform the steps described.

Further examples may include additional features. These include, but are not limited to, additional storage methods such as tweeting a cryptographic hash, a trusted ledger run by a third party, or email transmission. Additionally, these might include improving corroboration of the photograph by obtaining spatial information and data from various field of view lenses.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for creating a cryptographic signature from a user taken photo or video, including: a processing system, where: The system also includes a set of sensor data is collected from the photo or video. The system also includes a sensor data packet which is created from the set of sensor data. The system also includes the sensor data packet which is hashed for creation of a cryptographic signature. The system also includes a storage medium in communication with the processing system, where the cryptographic signature is stored. Other embodiments of this aspect include corresponding computer systems, apparatus, and computer programs recorded on one or more computer storage devices, each configured to perform the actions of the methods.

Various implementations may include one or more of the following features. The system where the storage medium is a database. The system where the storage medium is an internal ledger. The system the processing system further includes a storage file creation step. The system where the storage medium is in communication with the processing system via a cellular connection. The system where the storage medium is in communication with the processing system via a wi-fi connection. The system where the cryptographic signature is stored locally until communication with the storage medium can be established. The system further including a comparison step, where the stored cryptographic signature can be compared to the photo or video for authentication. The system where the processing step is configured to compare the cryptographic signature to a recreated storage file signature to detect alterations. A validation system where the database is a block chain. A validation system where the processing system. The validation system may also include creates a sensor data packet from the sensor data. The validation system may also include creates a storage file from the sensor data packet. A validation system where the storage file is sent to a server. A validation system where the storage file is held on the device until a network connection can be established. A validation system where the processing system uses the cryptographic signature to establish an internal ledger. A validation system where the internal ledger uploads periodically to the database. A validation system where the internal ledger is configured to compare the cryptographic signature to a recreated internal ledger signature to detect alterations. A validation system where a cryptographic signature is created from the storage file. A validation system where the cryptographic signature is uploaded to the database using a cellular connection. A validation system where the processing system of configured to measure and record a time lapse between storage of the sensor data and upload of the cryptographic signature. Implementations of the described techniques may include hardware, a method or process, or computer software on a computer-accessible medium.

One general aspect includes a validation system including: a database, the database configured to store sensor data; a processing system in communication with the database, where the processing system collects sensor data from a device. Other embodiments of this aspect include corresponding computer systems, apparatus, and computer programs recorded on one or more computer storage devices, each configured to perform the actions of the methods. Implementations may include one or more of the following features. A validation system where the database is a block chain. The validation system may also include creates a sensor data packet from the sensor data. The validation system may also include creates a storage file from the sensor data packet. A validation system where the storage file is sent to a server. A validation system where the storage file is held on the device until a network connection can be established. A validation system where the processing system uses the cryptographic signature to establish an internal ledger. A validation system where the internal ledger uploads periodically to the database. A validation system where the internal ledger is configured to compare the cryptographic signature to a recreated internal ledger signature to detect alterations. A validation system where a cryptographic signature is created from the storage file. A validation system where the cryptographic signature is uploaded to the database using a cellular connection. A validation system where the processing system is configured to measure and record a time lapse between storage of the sensor data and upload of the cryptographic signature. Implementations of the described techniques may include hardware, a method or process, or computer software on a computer-accessible medium.

While multiple embodiments are disclosed, still other embodiments of the disclosure will become apparent to those skilled in the art. As will be realized, the disclosed apparatus, systems, and methods are capable of modifications in various aspects, all without departing from the spirit and scope of the disclosure. Accordingly, the drawings and detailed description are to be regarded as illustrative in nature and not restrictive.

### BRIEF DESCRIPTION OF THE DRAWINGS

FIGS. 1A-B show exemplary embodiments of the validation system.

FIG. 2 shows an exemplary system for creation of a cryptographic signature.

FIG. 3 shows an exemplary implementation of the validation system.

FIGS. 4A-B depict flowcharts showing model embodiments of the validation system.

### DETAILED DESCRIPTION

The disclosed apparatus, systems, and methods relate to a validation system 10 capable of confirming the authenticity of data, such as digital photos, videos and other sensor information.

It is understood that the various embodiments of the validation system and related methods, and devices disclosed herein can be incorporated into or used with any other known validation systems, methods, and associated devices. For example, the various embodiments disclosed herein may in incorporated into or used with any of the systems, methods, and associated devices disclosed in copending U.S. Applications 62/244,651 (filed on Oct. 21, 2015 and entitled “Devices, Systems and Methods and Ground Plane”), Ser. No. 15/331,531 (filed Oct. 21, 2016 and entitled “Apparatus, Systems and Methods for Ground Plane Extension”), and 62/511,603 (filed May 26, 2017 and entitled “Industrial Augmented Reality System, Methods and Devices”) all of which are hereby incorporated herein by reference in their entireties.

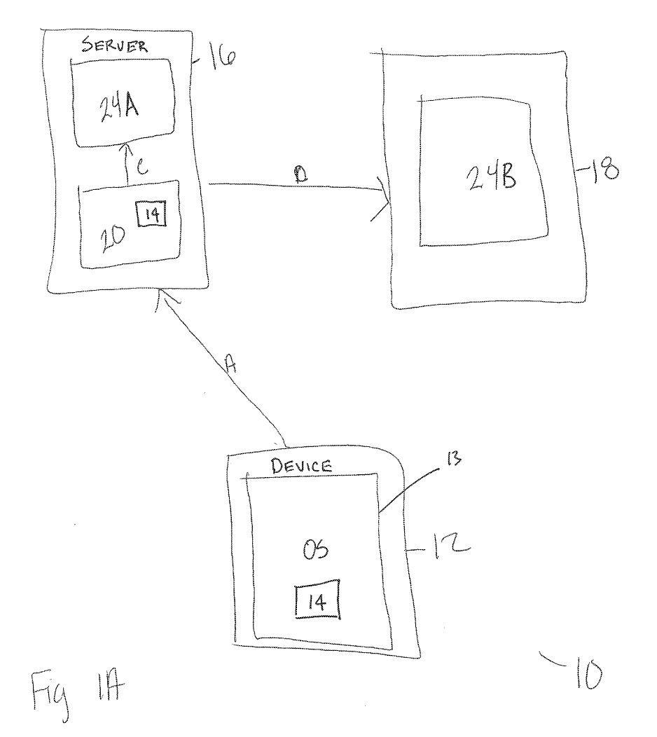

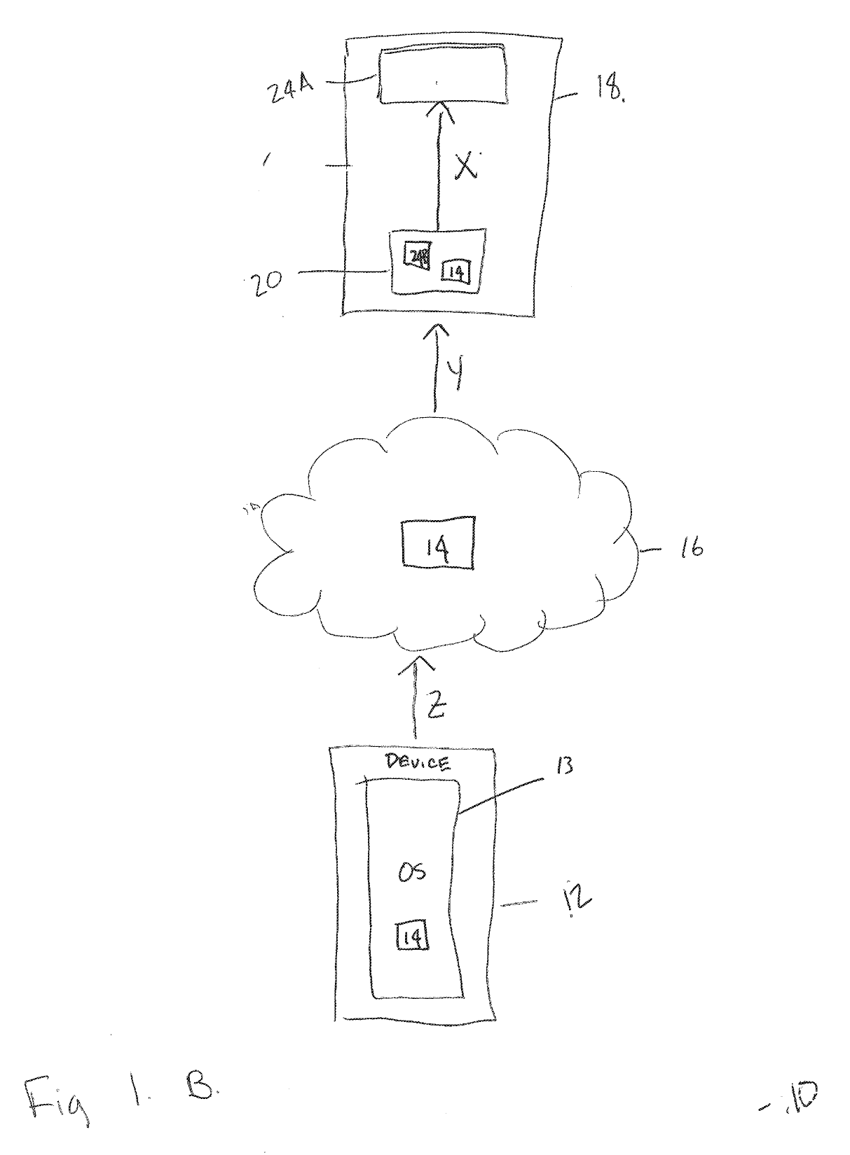

As shown in the implementations of FIGS. 1A-4B, the validation system 10 generally comprises collecting photos, videos and/or sensor data from a device 12. Certain non-limiting examples of devices may include; tablets and mobile phones. The photos, videos and/or sensor data are then converted into a storage file 14 such as a zip file 14 which can contain any of the collected data such as a sensor packet (as discussed below). In various implementations, the storage file 14 is then stored on a server 16 in a database. The data is also hashed to create a cryptographic signature 24, validating the integrity of the data. In certain implementations, the cryptographic signature 24 and time stamp is stored on another database 18, such as a block chain 18. The cryptographic signature 24 of these implementations can then be compared to a recreated signature from the storage file 14 in evidentiary proceedings or other events where detection of alterations is needed for authentication. In alternate embodiments, the validation system may be configured and arraigned to execute comparisons between the recreated and stored cryptographic signature. While several embodiments are described in detail herein, further embodiments and configurations are possible.

Turning to the drawings in greater detail, as show in FIG. 1A, an exemplary embodiment of the validation system 10, a device 12 contains a processing system 13 which can include a local database or other memory for collection and storage of the data. In these implementations, the device 12 is used to capture photos, videos and other associated sensor data for storage and transmission, as well as the assembly of the stored data. That is, the processing system 13 is used to convert the photos, videos, and sensor data (which can be a packet 14A) into a storage file 14 such as a zip file 14. In various embodiments the storage file 14 may contain only one photo or video, the storage file may contain many photos and videos, the storage file 14 many contain additional sensor data in addition to photos and videos. Certain non-limiting examples of additional sensor data may be the angle of the device, other cameras, location data, time and atmospheric pressure. In some embodiments more extensive sensor data, for example spatial information, could be collected. When the user 12 captures a photo or video, the processing system 13 stores sensor data locally in a sensor data packet which is converted into a storage file 14.

In these implementations, the storage file 14, such as a zip file 14, is sent to a server 16 such as a private server 16, following arrow A, where the storage file 14 is stored in a database 20. Following arrow C, the storage file 14 is then hashed to create a cryptographic signature 24A that is also stored on the server 16. The hash function allows for validating the integrity of the data contained in the storage file 14. In these implementations, a duplicate cryptographic signature 24B is then uploaded to a public block chain 18, following arrow D, such that the duplicate cryptographic signature 24B is stored on the public block chain 18 and is therefore highly tamper resistant. It is therefore understood that these stored cryptographic signatures 24A, 24B can be compared, using a variety of systems and methods appreciated by one of skill in the art, with a recreated signature from the stored storage file 14 to detect any alterations as needed for authentication.

FIG. 1B depicts an additional exemplary embodiment of the validation system 10. In this implementation, the device 12 contains a processing system 13. The device 12 captures photo, videos, and other sensor data. The processing system converts the data into a storage file 14 such as a zip file 14 that is uploaded to a server 16, following arrow Z, such as via a WiFi, cellular or other network. Some non-limiting examples of servers might include, but are not limited to, a client server, a company server, or cloud storage. In some embodiments the storage file 14 may be held in internal storage on the server 16 until a network connection can be established. Following arrow Y, according to these implementations, the storage file 14 is also uploaded for storage on a database 20 in a public block chain 44 in these implementations. The storage file 14 is converted into a cryptographic signature 24A, following arrow X, using a hash function to insure the integrity of the data. The cryptographic signature 24A is stored on a public block chain 18. The cryptographic signature 24A can then be compared to a recreated signature 24B from the storage file 14 as needed to detect alterations or for authentication.

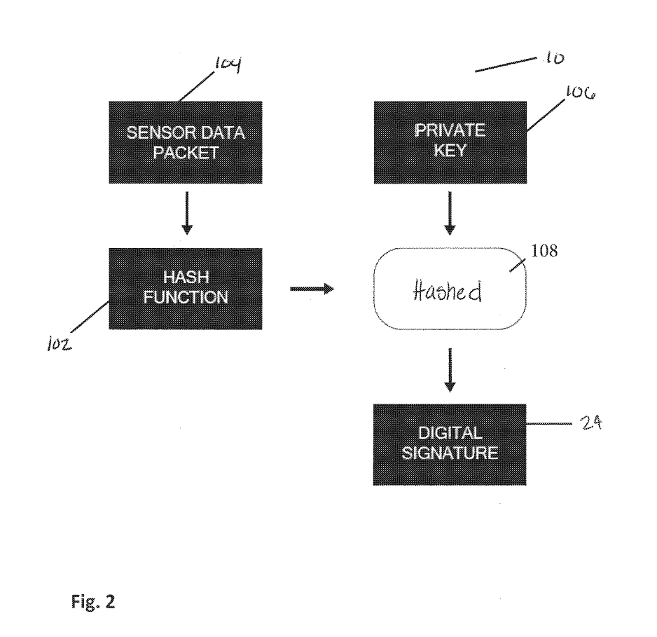

FIG. 2 depicts an exemplary embodiment of a processing system 10 as it creates a cryptographic signature 24 from a sensor data packet 104 or storage file (such as those shown in FIGS. 1A-1B at 14). In these implementations, a function such as a hash function 102 creates a storage file of the sensor data packet 104, as was discussed in relation to FIGS. 1A-1B. In these implementations, the storage file is hashed 108 with the private key 106. The result of these implementations is the creation of a cryptographic signature 24 that can be used to authenticate that the underlying data or sensor packet has not been disturbed or tampered with. That is, this process insures the integrity of the content by detecting modification via obvious changes to the hash output.

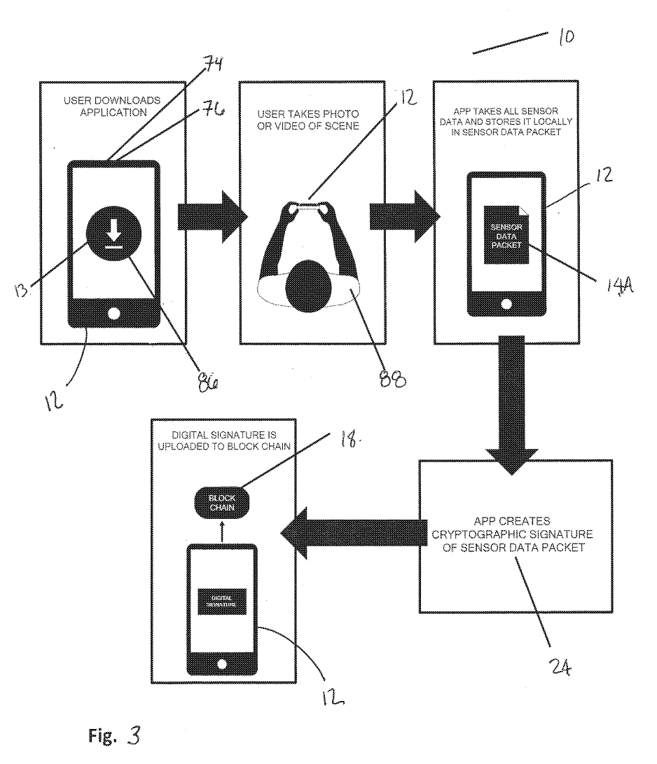

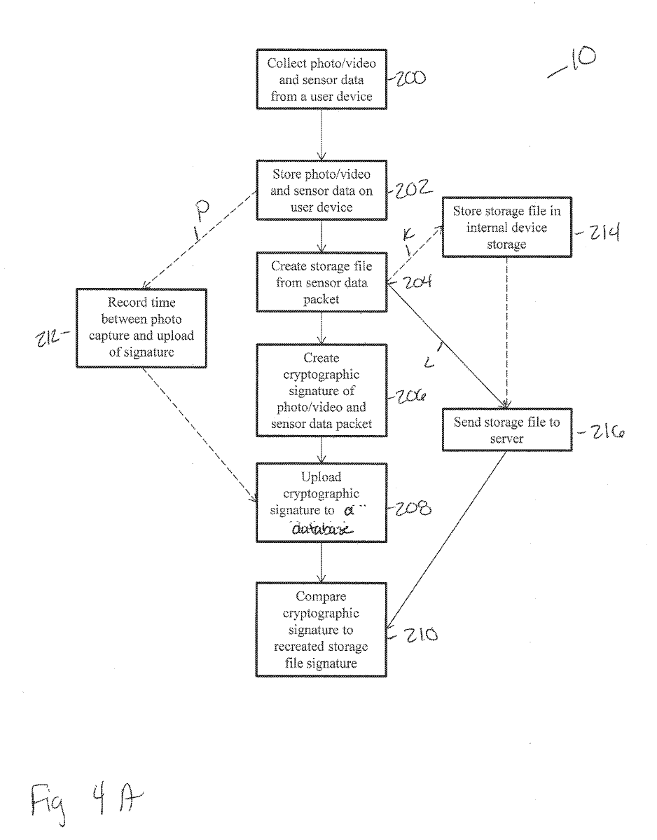

FIG. 3 is an exemplary implementation of the validation system, according to one implementation. In this implementation, a device 12 contains a mobile application 86 and is equipped with a transmission component 74. The transmission component can be cellular, Wi-Fi, or other system for communication appreciated by a skilled artisan.

In the implementation of FIG. 3, the device 12 is configured to record data from a sensor or sensors 76 when taking a photo or video, such as but not limited to; the angle of the device, other cameras, location data, time, and atmospheric pressure. In some embodiments more extensive sensor data, for example spatial information, could be collected. When the user 88 captures a photo or video, the processing system 13 stores sensor data locally in a data packet such as a sensor data packet 14A. It is understood that the data packets 14A can comprise one or more data modalities, such as audio, video, or other kinds of data. Other variations and implementations will be apparent to the skilled artisan.

It is also understood that in these implementations, the processing system 13 creates the cryptographic signature 24 from the sensor data packet 14A or storage file 14 via the hashing process described herein. The cryptographic signature 24 is unique to a specific sensor data packet 14A or storage file 14. In various implementations, the cryptographic signature 24 can be uploaded to a database 18, such as a private or public database, for use in later authentication or validation of the integrity of the stored data. In one embodiment, a database can be a block chain 18, which has technical characteristics, known in the art, that make it impossible to alter or otherwise tamper with.

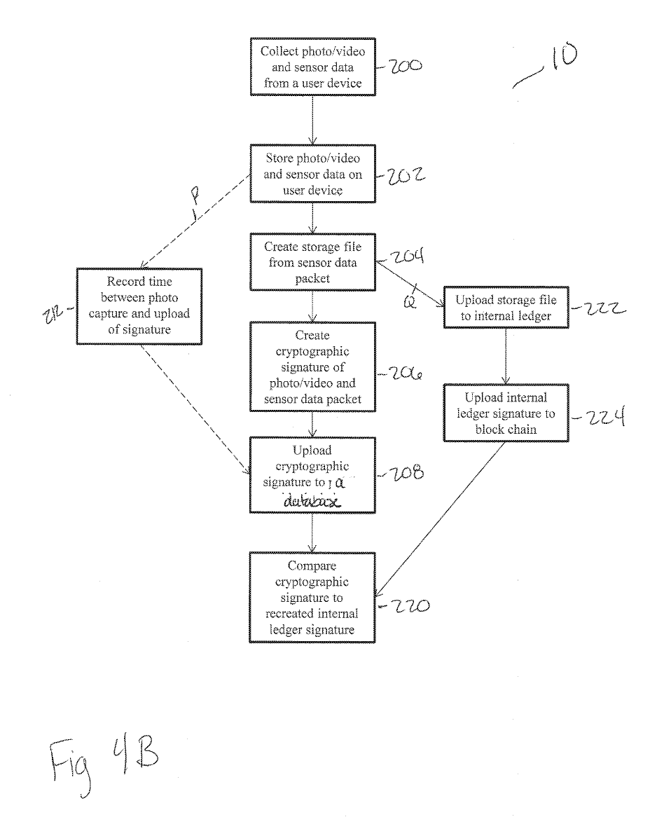

FIG. 4A depicts a flowchart showing a model embodiment of the validation system. In this embodiment, the validation system 10 collects 200 photo/video and sensor data from a user device (shown in FIG. 3 at 12) to form a data packet such as a sensor data packet, as was described above. The photo/video and sensor data is stored 202 on the user device, thereby creating a sensor data packet (shown above at 14A). Here, the processing system 10 thereby creates 204 a zip file, or other storage file, (again as shown in FIG. 1A at 14) from the sensor data packet. Following arrow L, the storage file is sent 216 to a server where is it saved. In an alternate embodiment the storage file is stored internally 214 within the device, following arrow K, until a network connection can be achieved when the storage file is then uploaded 216 to a server.

Continuing with FIG. 4A, in addition to saving 216 the storage file to a server, the system uses the storage file to create 206 a cryptographic signature for the contents of the sensor packet. The cryptographic signature is uploaded 208 to a database. In an alternate embodiment, following arrow P, the processing system can be configured to record 212 any lapse in time between when the photo/video and sensor data was captured and stored and when the cryptographic signature is uploaded. The cryptographic signature can then be compared 210 to a recreated signature from the stored storage file to detect any alterations and for authentication.

FIG. 4B depicts a flowchart showing a model embodiment of the validation system 10. In this embodiment, the validation system collects 200 photo/video and sensor data from a user device, such as those shown above at 12. The photo/video and sensor data is stored 202 on the user device, thereby creating a sensor data packet as has been previously described. Here, the processing system creates 204 a storage file from the sensor data packet. Following arrow Q the storage file is uploaded 222 to an internal ledger. The internal ledger is periodically signed and may be uploaded 224 to a block chain.

In addition to saving 222 the storage file to an internal ledger, the system 10 uses the storage file to create 206 a cryptographic signature for the contents of the sensor packet. The cryptographic signature is uploaded 208 to a database. In an alternate embodiment, following arrow P, the processing system can be configured to record 212 any lapse in time between when the photo/video and sensor data was captured and stored and when the cryptographic signature is uploaded. It is understood that the cryptographic signature can then be compared 220 to a recreated signature from the internal ledger to detect any alterations and for authentication.

In the various approaches of the various embodiments and implementation the validation system allows one to verify the authenticity of a photo or video by creating a cryptographic signature 206 from the storage file contents 204 and comparing 210, 220 the signature uploaded to the database for that photo or video to the photo or video at a later point in time. Possible methods of validation include, but are not limited to: examining the image and whether it was consistent with an overall evidence narrative, comparing the stated location and weather of the photo or video with the recorded data, and verifying that the motion of the forward and rear facing cameras were consistent with the motion of the phone at the time the photo was taken. In certain embodiments, an insurance company might use the validation system to periodically document the condition of property. In other embodiments, the system may be configured to detect alterations between the recreated and stored cryptographic signatures.

Although the disclosure has been described with reference to certain embodiments, persons skilled in the art will recognize that changes may be made in form and detail without departing from the spirit and scope of the disclosed apparatus, systems and methods. Such that the various embodiments and steps described can be performed in a variety of orders and combinations without departing from the scope of the disclosure.

What is claimed is:

1. A system for creating a cryptographic signature from a user taken photo or video, comprising:
(a) a processing system, wherein:
(i) a set of sensor data is collected from the photo or video;
(ii) a sensor data packet is created from the set of sensor data;
(iii) the sensor data packet is hashed for creation of a cryptographic signature; and
(b) a storage medium in communication with the processing system, where the cryptographic signature is stored.

2. The system of claim 1, wherein the storage medium is a database.

3. The system of claim 1, wherein the storage medium is an internal ledger.

4. The system of claim 1, the processing system further comprises a storage file creation step.

5. The system of claim 1, wherein the storage medium is in communication with the processing system via a cellular connection.

6. The system of claim 1, wherein the storage medium is in communication with the processing system via a Wi-Fi connection.

7. The system of claim 1, wherein the cryptographic signature is stored locally until communication with the storage medium can be established.

8. The system of claim 1, further comprising a comparison step, wherein the stored cryptographic signature can be compared to the photo or video for authentication.

9. The system of claim 1, wherein the processing step is configured to compare the cryptographic signature to a recreated storage file signature to detect alterations.

10. A validation system comprising:
(a) a database, the database configured to store sensor data;
(b) a processing system in communication with the database,
wherein the processing system collects sensor data from a device.

11. A validation system of claim 10, wherein the database is a block chain.

12. A validation system of claim 11, wherein the processing system;
(a) creates a sensor data packet from the sensor data; and
(b) creates a storage file from the sensor data packet.

13. A validation system of claim 12, wherein the storage file is sent to a server.

14. A validation system of claim 12, wherein the storage file is held on the device until a network connection can be established.

15. A validation system of claim 12, wherein a cryptographic signature is created from the storage file.

16. A validation system of claim 12, wherein the cryptographic signature is uploaded to the database using a cellular connection.

17. A validation system of claim 16, wherein the processing system of configured to measure and record a time lapse between storage of the sensor data and upload of the cryptographic signature.

18. A validation system of claim 14, wherein the processing system uses the cryptographic signature to establish an internal ledger.

19. A validation system of claim 18, wherein the internal ledger uploads periodically to the database.

20. A validation system of claim 19, wherein the internal ledger is configured to compare the cryptographic signature to a recreated internal ledger signature to detect alterations.
